(19) United States
(12) Patent Application Publication
(10) Pub. No.: US 2026/0024096 A1
(43) Pub. Date: Jan. 22, 2026

(54) Mapping Containment Risks in CO2 sequestration

(71) Applicant: Saudi Arabian Oil Company, Dhahran (SA)

(72) Inventors: Jinying Zhou, Dhahran (SA); Sylvester Egbeni, Dhahran (SA); Ahmed Al Ghamdi, Dhahran (SA); Sara A. Jazzar, Dhahran (SA)

(21) Appl. No.: 18/779,782

(22) Filed: Jul. 22, 2024

(51) Int. Cl. G06Q 30/018; G06Q 10/0635

(52) U.S. Cl. CPC G06Q 30/018; G06Q 10/0635

(57) ABSTRACT

A computer implemented method that enables mapping containment risks in CO2 sequestration is described. The method includes extracting datasets corresponding to wells that satisfy predetermined criteria from an exploration database. The extracted datasets are integrated to plumb a geological network, and an artificial intelligence model is iteratively trained to predict risk profile segments for areas corresponding to the exploration database using the geological network and clustered datapoints from the exploration database. A containment risk is mapped based on the predicted risk profile segments.

### TECHNICAL FIELD

This disclosure relates generally to hydrocarbon exploration, drilling, and production, and more particularly, to mapping containment risks in carbon dioxide (CO2) sequestration.

### BACKGROUND

Carbon dioxide and other greenhouse gases can be generated during hydrocarbon exploration, drilling, and production. Carbon capture and sequestration (CCS) enables storage of carbon dioxide and other greenhouse gases within oil and gas reservoirs. Carbon dioxide is injected into reservoirs comprising legacy wells, and can mix with fluids and gases in the reservoir. The injected carbon dioxide can be trapped either by the rock itself or by dissolving into groundwater and any hydrocarbons in the reservoir.

### BRIEF DESCRIPTION OF DRAWINGS

FIG. 1 shows legacy wells.

FIG. 2 is a well section diagram showing the legacy wells with varying degrees of well completion design.

FIG. 3 is a well section diagram showing the legacy wells and CO2 breaches.

FIG. 4 is a combined common risk segment (CCRS) map showing combined risk segment matrix of high, medium, and low containment risk based on assessment of completion data.

FIG. 5 is a workflow that enables mapping containment risk in CO2 sequestration.

FIG. 6 is a process flow diagram of a process that enables mapping containment risks in CO2 sequestration.

FIG. 7 illustrates hydrocarbon production operations that include both one or more field operations and one or more computational operations, which exchange information and control exploration for the production of hydrocarbons.

FIG. 8 is a schematic illustration of an example controller that enables mapping containment risks in CO2 sequestration.

### DETAILED DESCRIPTION

Embodiments described herein enable mapping containment risks of carbon dioxide (CO2) sequestration. Carbon capture and sequestration (CCS) is achieved in part by monitoring the injection of greenhouse gases into a storage site, such as wells of a reservoir or formation. Injected CO2 has the potential to migrate over time, which may be due to leakage of CO2 from storage sites. Storage sites are assessed for containment risk by characterizing the proposed storage site and identifying the containment risks. In examples, characterizing areas that are potential CO2 storage sites includes demonstrating that the risks are managed effectively.

In some embodiments, a combined common risk segment (CCRS) map of a region is created from datasets extracted from an exploration database. The CCRS map visualizes a spatial distribution of a containment risk assessment of reservoirs including multiple wells as potential storage sites. A relative suitability of wells, reservoirs, or other formations for CO2 sequestration is shown on the CCRS map according to a geologically referenced matrix.

In examples, the exploration database is a well-by-well database that includes data obtained during hydrocarbon exploration, drilling, and production. For example, the exploration database contains subsurface geological information on wells drilled for oil and gas production. The exploration database also includes geological and geophysical data associated with the subsurface. In examples, the data in the exploration database includes well header data, biostratigraphy, reservoir characteristics, velocity and directional surveys, and organic geochemistry for each respective well or formation. Additionally, in examples the exploration database includes data on wells, geophysical surveys, titles, and other related exploration and production data.

Datasets are extracted from the exploration database based on predetermined criteria. In some embodiments, the predetermined criteria includes wells with at least one Cement Bond Log (CBL), wells with a drilling well diagram, wells with at least one plug zone, wells with a cement shoe lithology, or any combinations thereof. In examples, the at least one CBL is a representation of the integrity of the cement job of a drilled well. In some embodiments, the CBL is visualized by a single line representing the integrated integrity around the casing. In examples, the CBL data indicates whether the cement is adhering solidly to the outside of the casing. In examples, the CBL is obtained using tool such as a sonic-type tool. In some embodiments, the CBL is a cement evaluation logs and is visualized using a 360° representation of the integrity of the cement job.

In some embodiments, the drilling well diagram shows the appearance, structure, or workings of a drilled well. For example, the drilling well diagram identifies at least one main completion component installed in a wellbore. In examples, the data included in the drilling well diagram includes the principal dimensions of the components and the depth at which the components are located. A drilling well diagram enables selection of the most appropriate equipment for CCS, and also enables the preparation of operating procedures at a respective well.

In some embodiments, a plug zone is a solid body within a drilled well. Data associated with a plug zone includes a sealing capacity of the caprock overlying a respective well, despite faults and/or fractures that occur in the respective well. The data associated with the plug zone enables an assessment of the long-term integrity of sealing formations. In examples, accurate characterization of CO2 leakage along potential high-permeability pathways (e.g., at or near the plug zone) into near-surface aquifers or to the surface enables the identification of wells that are appropriately sealed for use as a CO2 storage site.

In some embodiments, data associated with a cement shoe lithology describes the macroscopic nature of the mineral content, grain size, texture and color of the cement shoe. In examples, a shoe refers to the bottom of the casing string, including the cement around it, or the equipment run at the bottom of the casing string.

In some embodiments, the predetermined criteria include wells with at least one of a CBL, drilling well diagram, plug zone, of a cement shoe lithology. In some embodiments, the predetermined criteria include wells with each of a CBL, drilling well diagram, plug zone, of a cement shoe lithology. The predetermined criteria is applied to available datasets to extract data that can be used to characterize the proposed storage site (e.g., drilled well) and identify the containment risks associated with the drilled well.

The extracted datasets are integrated to determine features that indicate areas of varying containment risks. In examples, the containment risk refers to a possibility of failed containment of CO2, such as CO2 leakage from the injected areas. Datasets are used to determine containment risk profile segments for areas corresponding to datapoints of a respective dataset. For areas with low data coverage (e.g., missing or a lack of datapoints) in the extracted datasets, an artificial intelligence model is trained to predict containment risk profile segments.

Common risk segment mapping is a computer technology for identifying CO2 storage sites and systematically evaluating geologic formations for storage potential using an artificial intelligence model. An artificial intelligence model is used to classify inputs based on a previous training process. This technology has several different potential uses, ranging from characterizing and developing storage sites and translating multi-dimensional datasets into chance of success maps. Some prior methods use mechanical ways of identifying legacy well containment risk. In some embodiments, an artificial intelligence model classifies areas according to a predefined structure, such as a low risk of leakage, a medium risk of leakage, or a high risk of leakage, based upon the model being previously trained on a set of extracted datasets. Prior methods suffer from the inability to assess containment risk in areas of low data coverage based on fluid dynamics to prevent geo-hazards associated with CCS.

The present techniques addresses the assessment of containment of risk in areas of low data coverage by using a combination of features to more robustly identify potential paths for leakage. A first feature is associated with caprock and properties. A second feature is associated with the reservoir and properties. A third feature is a completion scheme plot. These features are extracted by comparing and contrasting datasets to determine correlations or patterns in the data that indicate leakage paths. A geological network is constructed, and an artificial intelligence model is iteratively trained with the set of features. The machine learning model is iteratively trained and tested using clusters of dense data from the generated features. The trained and tested artificial intelligence model is executed on sparse data from the extracted datasets. In examples, the trained and tested artificial intelligence model predicts risk profile segments that are used to generate a CCRS map.

Some advantages of the present techniques include an improvement to CO2 sequestration by robust predictions of areas with varying risks for CO2 sequestration. The assessment of containment integrity is used for accurate evaluation and approval of potential CO2 storage areas. The present techniques also assess the safety and containment integrity of the geological storage of CO2 by quantifying risks of leakage, which enables a more precise visualization of the containment risk assessment. Leakage of CO2 from the storage areas can, for example, negatively impact human health, cause environmental harm, and impair industrial activity. The present techniques mitigate the potential environmental pollution risk in CO2 sequestration and helps to mitigate associated human causative risk.

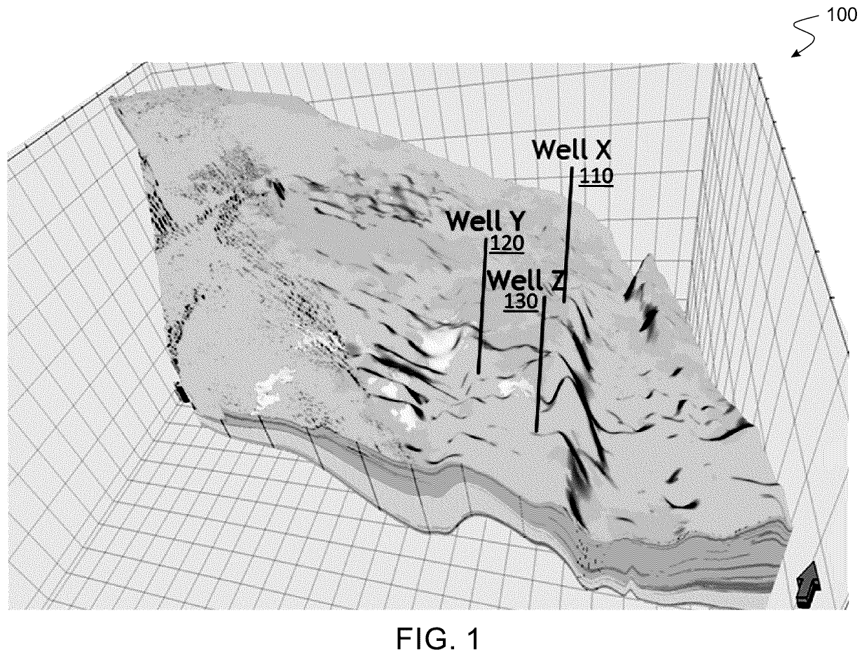

FIG. 1 shows legacy wells. In some embodiments, the legacy wells are assessed for containment risk, and the likelihood of CO2 leakage is quantified for respective legacy wells. In examples, legacy wells are wells drilled for another function, such as oil and gas wells, water wells, geothermal wells, and the like. In some embodiments, the legacy wells 110, 120, and 130 are evaluated to determine risks associated with CO2 sequestration. Legacy wells are probable pathways for CO2 leakage at storage sites, such as sequestered CO2 sinks. Risks of CO2 leakage rise when CO2 is sequestered in or close to existing hydrocarbon fields with many wells.

In some embodiments, datasets are logically mined and integrated to produce a CCRS. For example, datasets are extracted from an exploration database and are used to determine a containment risk profile corresponding to areas with datapoints in the extracted datasets. For example, legacy wells are logged and include well log data in the exploration database. Containment risk profiles for areas with low data coverage in the exploration database are predicted using a trained artificial intelligence model. The trained artificial intelligence model predicts containment risk profile segments for areas with low data coverage. In some embodiments, an artificial intelligence model is used to predict containment risk profile segments indicating a high risk of leakage from legacy wells with poor completion. The areas with containment risk profile segments indicating a high risk of leakage are removed from consideration as CO2 injection areas or storage sites. The containment risk profiles are combined to create a CCRS map. Accordingly, in some embodiments the legacy wells and storage sites with low data coverage are ranked according to an associated containment risk by integration of geological information and drilling information from well completions data.

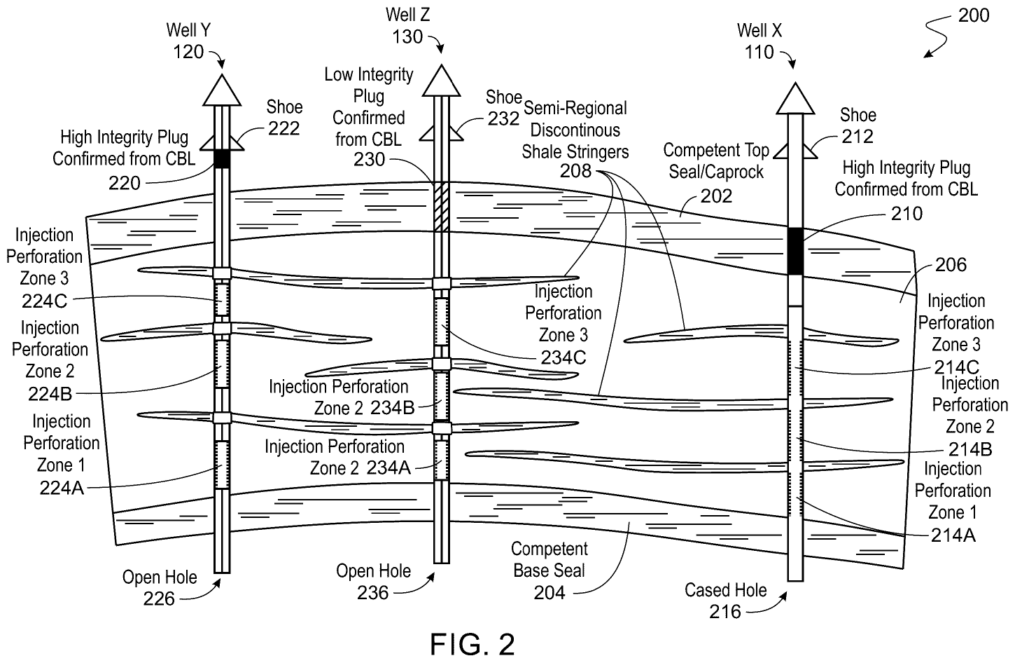

FIG. 2 is a well section diagram showing the legacy wells 110, 120, and 130 with varying degrees of well completion design. Layer 202 represents competent top seal/caprock, and layer 204 represents a competent base seal. Layer 206 represents a layer of shale rock. Semi-regional regional shale stringers 208 extend throughout well section 206.

Well Y 120 is plugged above the regional seal/caprock layer 120 as shown by the high integrity plug 220 below the shoe 222 with an open hole 226. In some embodiments, the high integrity plug is confirmed from a cement bond log (CBL). Well Y 120 is crossed by three semi-regional discontinuous shale stringers 208, with perforations 224A, 224B, and 224C below respective semi-regional discontinuous shale stringers 208. In examples, wells with an open-hole are associated with a high risk of leakage through the open-hole up to the plug, breaching the top seal/caprock 202. Well Y 120 is considered to have a high containment risk, where there is a high likelihood of CO2 leakage if Well Y 120 is injected with CO2.

Well Z 130 is plugged in the regional seal/caprock layer 202 as shown by the low integrity plug 230 below the shoe 232 with an open hole 226. In some embodiments, the low integrity plug 230 is confirmed from the CBL. Well Z 130 is crossed by three semi-regional discontinuous shale stringers 208, with perforations 234A, 234B, and 234C below respective semi-regional discontinuous shale stringers 208. As discussed above, wells with an open-hole are associated with a high risk of leakage through the open-hole up to the plug, breaching the top seal/caprock 202. Well Z 130 is considered to have a high/medium containment risk, where there is a high/medium likelihood of CO2 leakage if Well Z 130 is injected with CO2.

Well X 110 is plugged in the regional seal/caprock layer 202 as shown by the high integrity plug 210 below the shoe 212 with a cased hole 216. In some embodiments, the high integrity plug 210 is confirmed from the CBL. Well X 110 is crossed by three semi-regional discontinuous shale stringers 208, with perforations 214A, 214B, and 214C below respective semi-regional discontinuous shale stringers 208. Wells with a cased-hole are associated with a low risk of leakage between the cased-hole up to the plug. Well X 130 is considered to have a low containment risk, where there is a low likelihood of CO2 leakage if Well X 110 is injected with CO2.

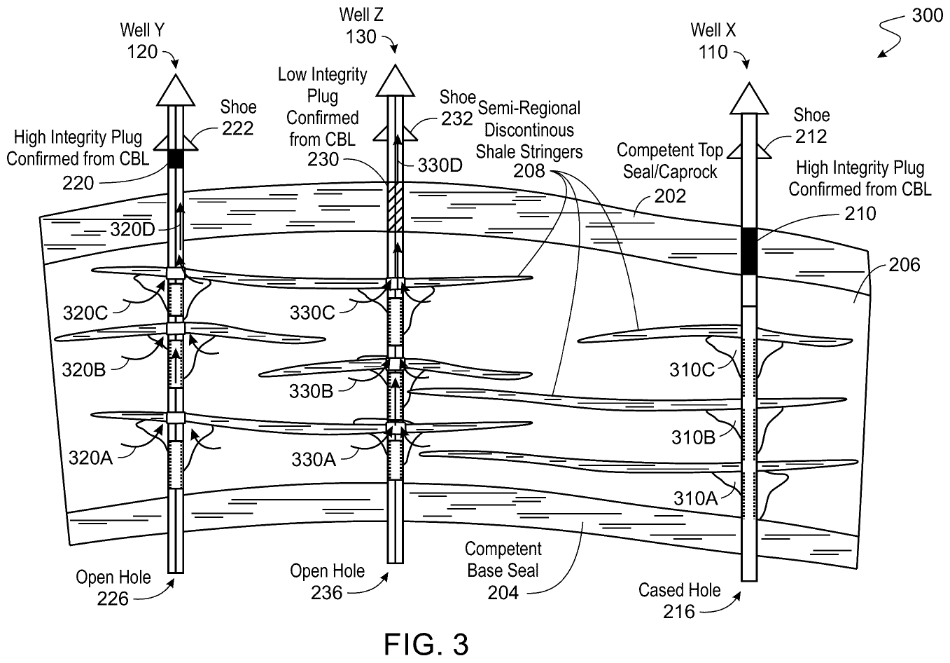

FIG. 3 is a well section diagram showing the legacy wells 110, 120, and 130 and CO2 breaches. FIG. 3 is an example of a plumbing diagram with varying degrees of well completion design and potential leakage paths of CO2. At Well Y 120, leakage and CO2 breaches occur through the well itself, such as at perforations 320A, 320B, and 320C, and the top seal 320D. Leakage and CO2 breaches may also occur with the help of the open hole 226, without a plug. During the drilling of Well Y 120, no plug was used to seal the location of the competent formation before changing the hole size. Well Y 120 is considered a potential high-risk leakage well with a high volume of CO2 escaping to the surface.

Well Z 130 is plugged 230 within the seal/caprock, but the CBL indicates the cement job is poor. At Well Z 130, CO2 breaches occur through the well itself at perforations 330A, 330B, and 330C, and the top seal 320D. Leakage and CO2 breaches may also occur with the help of the open hole 236, without a plug. Well Z 130 is considered a high-risk leakage well with a high volume of CO2 escaping to the surface.

Well X 110 is cased 216 and plugged 210 within the seal/caprock, and the CBL indicates the cement job is a high integrity cement job with no risk of leakage. At Well X 110, CO2 breaches do not occur at perforations 310A, 310B, and 310C or the plug 210. Well X 110 is considered a low containment risk a low likelihood of CO2 escaping to the surface.

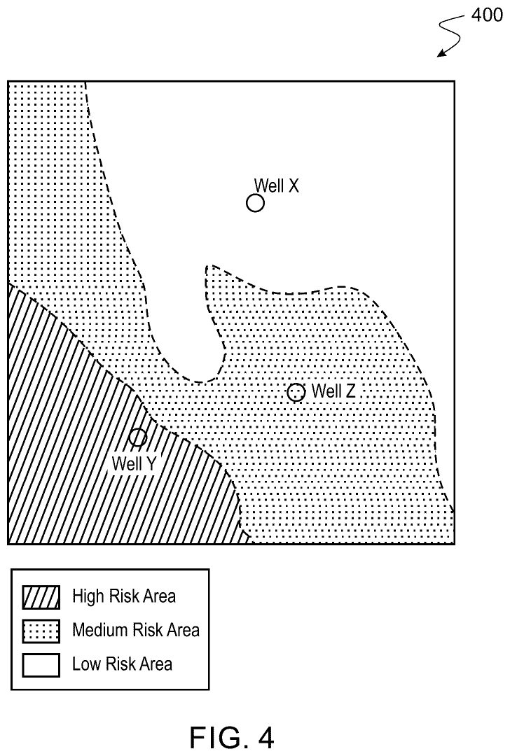

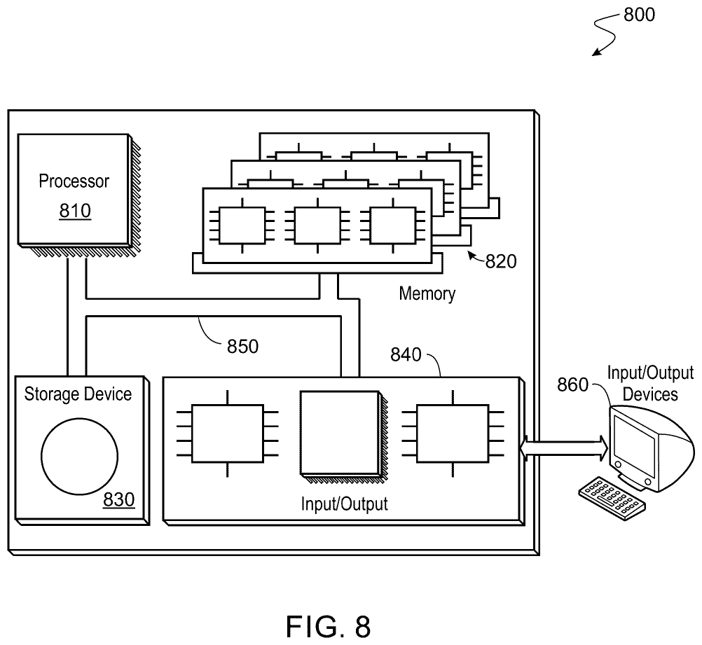

FIG. 4 is a combined common risk segment (CCRS) map showing combined risk segment matrix of high, medium, and low containment risk based on assessment of completion data. In some embodiments, the map is visualized at an input/output devices communicatively coupled with a controller, such as controller 800 and input/output devices 860 of FIG. 8. In examples, even if there is a technical justification for CO2 injection in the high risk area at Well Y, the CCRS map 400 suggests otherwise. Accordingly, CO2 injection at Well Y is likely inefficient and prone to leaks. In some embodiments, the map is used to identify areas that are high risk for CO2 leakage and help place wells efficiently.

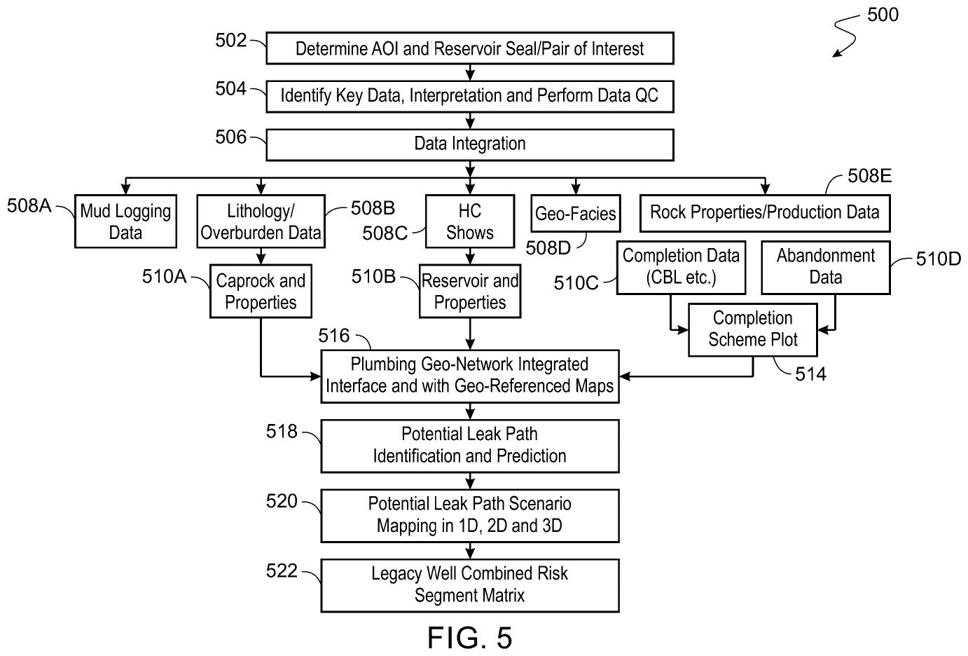

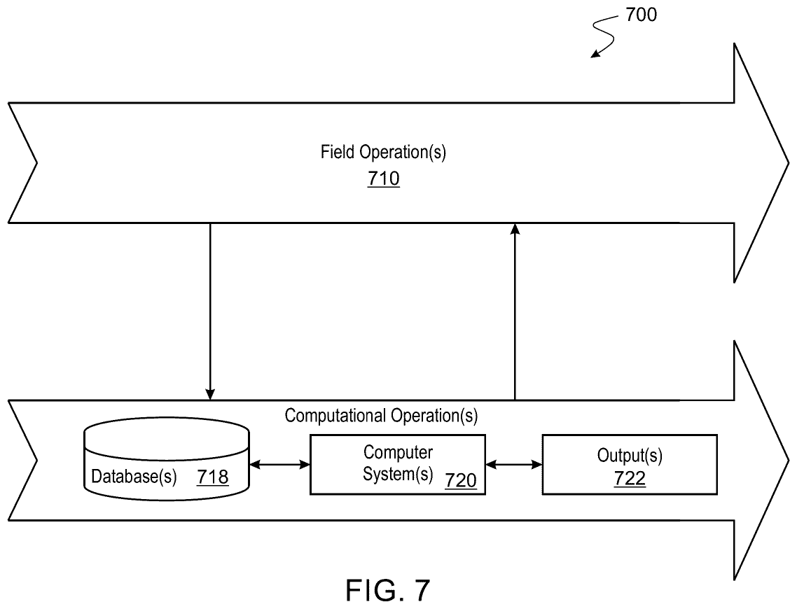

FIG. 5 is a workflow that enables mapping containment risk in CO2 sequestration. The process flow of FIG. 5 can be executed in conjunction with the hydrocarbon production operations 700 of FIG. 7 or by the controller 800 of FIG. 8.

At block 502, an area and reservoir seal/pair for mapping are determined. In examples, the area is a portion of a region to be mapped, and is selected based on prospects for CO2 injection. In examples, the reservoir seal/pair refers to a potential reservoir and seal rocks overlying a corresponding primary injection reservoir. In some embodiments, the area is selected based on the presence of legacy wells according to predetermined criteria. An exploration database corresponding to the selected area is mined to extract datasets for mapping containment risk in CO2 sequestration. A search for wells with particular list of criteria will produce the data that satisfy the predetermined criteria. In some embodiments, the predetermined criteria include wells with at least one of a CBL, drilling well diagram, plug zone, or a cement shoe lithology. In some embodiments, the predetermined criteria include wells with each of a CBL, drilling well diagram, plug zone, of a cement shoe lithology. The predetermined criteria is applied to available datasets to extract data that can be used to characterize the proposed storage site (e.g., drilled well) and identify the containment risks associated with the drilled well.

At block 504, key data is identified. In examples, key data corresponds to the extracted datasets. Key data includes data from well logs, completion logs, testing data, well completion data, planning diagrams, and the like. Key data is identified by querying an exploration database including drilled wells, and extending the search to cover drilling completion information according to the predetermined criteria. The identified key data is interpreted and data quality control is performed on the extracted datasets. Interpretation includes reviewing the datasets and arriving at observations associated with suitability for CCS based on each independent dataset. In examples, interpretations draws relevant conclusions or observations using various analytical research methods. Data quality control refers to filtering the data to remove datapoints that do not satisfy overall quality goals and defined quality criteria for individual datapoints of a respective dataset.

At block 506, the data is integrated. The integrating data refers to comparing observations from the extracted datasets. In examples, completion data is compared to mud-logging data. Cement log data is compared to fracture test data. Comparing and contrasting different datasets yields further evidence of containment risk in the form of containment risk profiles. The containment risk profiles are arbitrated according to the strength of observations from the different datasets. In an example, the completion data strongly indicates a high risk for contamination from a well as a CO2 storage site while the mud-logging data slightly indicates a risk for contamination from a well as a CO2 storage site. The datasets are integrated to obtain features that represent containment risk profiles corresponding to predetermined features.

Datasets are shown at blocks 508A, 508B, 508C, 508D, and 508E (collectively referred to as datasets 508). Dataset 508A includes mud logging data. Dataset 508B includes lithology/overburden data. Dataset 508C includes hydrocarbon shows. Dataset 508D includes geo-facies data. Dataset 508E includes rock properties/production data.

The integration results in features 510A, 510B, 510C, and 510D (collectively referred to as features 510). The features 510A include caprock and properties. The features 510B include reservoir and properties. The features 510C include completion data. The features 510D include abandonment data.

At block 512, the features 510C and the features 510D are combined to form a completion scheme plot 514. The completion scheme plot of the final well design at the time of when the well total depth is reached. The completion scheme plot shows the appearance, structure, or workings well when it was abandoned.

At block 516, the features 510A, features 510B and completion scheme plot 514 are used to construct a geological network integrated interface and with geologically referenced maps. In some embodiments, the geological network forms the spatial structure used to train an artificial intelligence model. The geologically referenced maps are maps include real-world location coordinates (e.g., X and Y coordinates; X, Y, Z coordinates) that can be located precisely on the ground with minimal error.

In examples, constructing the geological network includes predicting how fluid in the subsurface moves or interacts in the presence or absence of leakages. For example, when a well is drilled through a reservoir with baffles, the well and formation will be connected (interfaced). An interface between wells with a medium or high containment risk causes high risk of CO2 leakage. If two leaking points are connected (e.g., wells with a medium or high containment risk), a probability of leakage is increased. Similarly, if two leaking points are not connected, a probability of leakage is decreased. The geological network is an arrangement of paths, where subsurface fluid and gas moves or interacts along the paths. The geological network, including interfaces between wells, is constructed based on, at least in part, features obtained by integrating the extracted datasets.

At block 518, a potential leak path identification between areas of low, medium, and high containment risks in the CCRS are determined. This prediction is performed by assessing the completion data, cementing report or CBL logs, caprock property assessment and reservoir property and connectivity assessment is conducted. When all data points are integrated, the potential leak pathways are identified and leakage points will predicted. In some embodiments, the leak path is identified when plugs are observed to be located at a wrong position. In examples, the wrong position is, for example, not being placed on a regional seal such as in a cased hole scenario. In an open hole scenario, the wrong position allows direct fluid flow at the plug. In examples, potential leak paths are identified by linking facies and reservoir connectivity to fluid path migration through shallow completions and poor cement bond log during drilling and completions, as identified in the constructed geological network.

In some embodiments, a trained artificial intelligence model integrates datasets at a regional and local scale. In examples, the artificial intelligence model is trained to integrate data at a regional scale and a local, smaller scale. The artificial intelligence model is trained to predict risk profile segments. Inputs to the artificial intelligence model that predicts areas with high risk of leakage from legacy wells with poor completion includes, for example, structural maps, fluid migration models, legacy well distribution with poor completion to good completion, facies distribution, top seal data and strength information etc.

In some embodiments, the artificial intelligence model is trained to predict areas with a high risk of leakage from legacy wells with poor completion. The artificial intelligence model is trained by learning from a few dense, clustered data points. Then a blind test is conducted in a confirmed well that has bad completion and is known to be leaking. A blind test is also performed using a competent well with excellent completion. The artificial intelligence model is trained with various data, i.e. good caprock, poor caprock, poor reservoir connectivity etc. with known data. When the blind test results has a 90-95% similarity with the real-world data, the model is considered validated and will predict accurate results for areas with sparse data (e.g., areas with low data coverage).

In examples, the artificial intelligence model is trained and tested using datasets associated with clustered areas. Clustering is an unsupervised machine-learning approach that is used to group comparable data points based on specific traits or attributes. In examples, clustering forms groups of homogeneous data points from a heterogeneous dataset. Clustering evaluates the similarity based on a metric like Euclidean distance, Cosine similarity, Manhattan distance, etc. and then groups the points with highest similarity score together.

In some embodiments, the predicted risk profile segments are mapped to form CCRS maps. At block 520, potential leak path scenarios are mapped in one-dimension (1D), two-dimension (2D), and three-dimension (3D). In examples, the potential leak path scenarios show varying levels of CO2 stored in the mapped area. In examples, a CCRS map includes multiple scenarios, where leaks in a respective scenario are associated with a perceived chance of occurrence. In some embodiments, the mapping is first done in 1D before moving into 2D or 3D. The map type is data dependent and area dependent. In some embodiments, a 3D CCRS map is super-imposed on a structural depth map with known inclination, and the area spread of leakage fluid is determined using the super-imposed map.

At block 522, a CCRS map is generated based on the predicted risk profile segments. In some embodiments, common risk segment mapping is performed in hydrocarbon exploration and can be used to screen CO2 storage sites. In some embodiments, a CCRS map is created using a predefined approach to geologic evaluation. The features are translated into chance-of-success maps. In some embodiments, the trained artificial intelligence model outputs CCRS maps that include multiple scenarios that characterize the risk of leakage at a potential storage site. In some embodiments, the CCRS map is used to identify high risk areas not suitable for CO2 injection.

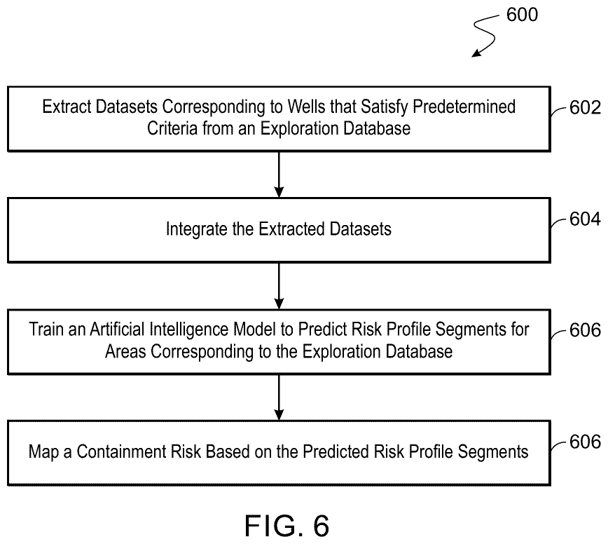

FIG. 6 is a process flow diagram of a process 600 that enables mapping containment risks in CO2 sequestration. The process flow of FIG. 6 can be executed in conjunction with the hydrocarbon production operations 700 of FIG. 7 or by the controller 800 of FIG. 8.

At block 602, datasets corresponding to wells that satisfy predetermined criteria are extracted from an exploration database. In some embodiments, the predetermined criteria include wells with at least one of a CBL, drilling well diagram, plug zone, of a cement shoe lithology. In some embodiments, the predetermined criteria include wells with each of a CBL, drilling well diagram, plug zone, of a cement shoe lithology. The predetermined criteria is applied to available datasets to extract data that can be used to characterize the proposed storage site (e.g., drilled well) and identify the containment risks associated with the drilled well.

At block 604, the extracted datasets are integrated by comparing observations in different extracted datasets to obtain features to plumb a geological network. In examples, areas with low data coverage are determined using a geologically referenced map. The distribution of the data is used to determine data coverage throughout the region. In examples, clustering is used to obtain training data for an artificial intelligence model.

At block 606, an artificial intelligence model is trained to predict risk profile segments for areas corresponding to the exploration database. In examples, the artificial intelligence model is iteratively trained using the geological network and clustered datapoints from the exploration database.

At block 608, a containment risk is mapped based on the predicted risk profile segments. For each legacy well, containment well risk is isolated from a regional distribution of wells based on correlations with well completion zones to highlight thief zones.

FIG. 7 illustrates hydrocarbon production operations 700 that include both one or more field operations 710 and one or more computational operations 712, which exchange information and control exploration for the production of hydrocarbons. In some implementations, outputs of techniques of the present disclosure can be performed before, during, or in combination with the hydrocarbon production operations 700, specifically, for example, either as field operations 710 or computational operations 712, or both.

Examples of field operations 710 include forming/drilling a wellbore, hydraulic fracturing, producing through the wellbore, injecting fluids (such as water) through the wellbore, to name a few. In some implementations, methods of the present disclosure can trigger or control the field operations 710. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 710 and responsively triggering the field operations 710 including, for example, generating plans and signals that provide feedback to and control physical components of the field operations 710. Alternatively or in addition, the field operations 710 can trigger the methods of the present disclosure. For example, implementing physical components (including, for example, hardware, such as sensors) deployed in the field operations 710 can generate plans and signals that can be provided as input or feedback (or both) to the methods of the present disclosure.

Examples of computational operations 712 include one or more computer systems 720 that include one or more processors and computer-readable media (e.g., non-transitory computer-readable media) operatively coupled to the one or more processors to execute computer operations to perform the methods of the present disclosure. The computational operations 712 can be implemented using one or more databases 718, which store data received from the field operations 710 and/or generated internally within the computational operations 712 (e.g., by implementing the methods of the present disclosure) or both. For example, the one or more computer systems 720 process inputs from the field operations 710 to assess conditions in the physical world, the outputs of which are stored in the databases 718. For example, seismic sensors of the field operations 710 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 712 where they are stored in the databases 718 and analyzed by the one or more computer systems 720.

In some implementations, one or more outputs 722 generated by the one or more computer systems 720 can be provided as feedback/input to the field operations 710 (either as direct input or stored in the databases 718). The field operations 710 can use the feedback/input to control physical components used to perform the field operations 710 in the real world.

For example, the computational operations 712 can process the seismic data to generate three-dimensional (3D) maps of the subsurface formation. The computational operations 712 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 712 to process new information about the formation and control the drilling to adjust to the observed conditions in real-time.

The one or more computer systems 720 can update the 3D maps of the subsurface formation as information from one exploration well is received and the computational operations 712 can adjust the location of the next exploration well based on the updated 3D maps. Similarly, the data received from production operations can be used by the computational operations 712 to control components of the production operations. For example, production well and pipeline data can be analyzed to predict slugging in pipelines leading to a refinery and the computational operations 712 can control machine operated valves upstream of the refinery to reduce the likelihood of plant disruptions that run the risk of taking the plant offline.

In some implementations of the computational operations 712, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second (s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

FIG. 8 is a schematic illustration of an example controller 800 (or control system) that enables mapping containment risks in CO2 sequestration. For example, the controller 800 may be operable according to the workflow 500 of FIG. 5 or the process 600 of FIG. 6. In some embodiments, the controller 800 is the same as or similar to the computer systems 720 of FIG. 7. The controller 800 is intended to include various forms of digital computers, such as printed circuit boards (PCB), processors, digital circuitry, or otherwise parts of a system for supply chain alert management. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 800 includes a processor 810, a memory 820, a storage device 830, and an input/output interface 840 communicatively coupled with input/output devices 860 (for example, displays, keyboards, measurement devices, sensors, valves, pumps). Each of the components 810, 820, 830, and 840 are interconnected using a system bus 850. The processor 810 is capable of processing instructions for execution within the controller 800. The processor may be designed using any of a number of architectures. For example, the processor 810 may be a CISC (Complex Instruction Set Computers) processor, a RISC (Reduced Instruction Set Computer) processor, or a MISC (Minimal Instruction Set Computer) processor.

In one implementation, the processor 810 is a single-threaded processor. In another implementation, the processor 810 is a multi-threaded processor. The processor 810 is capable of processing instructions stored in the memory 820 or on the storage device 830 to display graphical information for a user interface on the input/output interface 840.

The memory 820 stores information within the controller 800. In one implementation, the memory 820 is a computer-readable medium. In one implementation, the memory 820 is a volatile memory unit. In another implementation, the memory 820 is a nonvolatile memory unit.

The storage device 830 is capable of providing mass storage for the controller 800. In one implementation, the storage device 830 is a computer-readable medium. In various different implementations, the storage device 830 may be a floppy disk device, a hard disk device, an optical disk device, or a tape device.

The input/output interface 840 provides input/output operations for the controller 800. In one implementation, the input/output devices 860 includes a keyboard and/or pointing device. In another implementation, the input/output devices 860 includes a display unit for displaying graphical user interfaces.

There can be any number of controllers 800 associated with, or external to, a computer system containing controller 800, with each controller 800 communicating over a network. Further, the terms “client,” “user,” and other appropriate terminology can be used interchangeably, as appropriate, without departing from the scope of the present disclosure. Moreover, the present disclosure contemplates that many users can use one controller 800 and one user can use multiple controllers 800.

### Embodiments/Examples

According to some non-limiting embodiments or examples, provided is a computer-implemented method that enables mapping a containment risk in carbon dioxide (CO2) sequestration, including: extracting datasets corresponding to wells that satisfy predetermined criteria from an exploration database; integrating the extracted datasets by comparing observations from different extracted datasets to obtain features used to construct a geological network; training an artificial intelligence model to predict risk profile segments for areas corresponding to the exploration database, wherein the artificial intelligence model is iteratively trained using the geological network and clusters of dense datapoints from the exploration database; and mapping a containment risk based on the predicted risk profile segments.

According to some non-limiting embodiments or examples, provided is an apparatus including a non-transitory, computer readable, storage medium that stores instructions that, when executed by at least one processor, cause the at least one processor to perform operations including: extracting datasets corresponding to wells that satisfy predetermined criteria from an exploration database; integrating the extracted datasets by comparing observations from different extracted datasets to obtain features used to construct a geological network; training an artificial intelligence model to predict risk profile segments for areas corresponding to the exploration database, wherein the artificial intelligence model is iteratively trained using the geological network and clusters of dense datapoints from the exploration database; and mapping a containment risk based on the predicted risk profile segments.

According to some non-limiting embodiments or examples, provided is a system, including: one or more memory modules; one or more hardware processors communicably coupled to the one or more memory modules, the one or more hardware processors configured to execute instructions stored on the one or more memory modules to perform operations including: extracting datasets corresponding to wells that satisfy predetermined criteria from an exploration database; integrating the extracted datasets by comparing observations from different extracted datasets to obtain features used to construct a geological network; training an artificial intelligence model to predict risk profile segments for areas corresponding to the exploration database, wherein the artificial intelligence model is iteratively trained using the geological network and clusters of dense datapoints from the exploration database; and mapping a containment risk based on the predicted risk profile segments.

Further non-limiting aspects or embodiments are set forth in the following numbered embodiments:

Embodiment 1: A computer-implemented method that enables mapping a containment risk in carbon dioxide (CO2) sequestration, including: extracting datasets corresponding to wells that satisfy predetermined criteria from an exploration database; integrating the extracted datasets by comparing observations from different extracted datasets to obtain features used to construct a geological network; training an artificial intelligence model to predict risk profile segments for areas corresponding to the exploration database, wherein the artificial intelligence model is iteratively trained using the geological network and clusters of dense datapoints from the exploration database; and mapping a containment risk based on the predicted risk profile segments.

Embodiment 2: The computer implemented method of any preceding embodiment, the predetermined criteria includes wells with at least one Cement Bond Log (CBL), wells with a drilling well diagram, wells with at least one plug zone, wells with a cement shoe lithology, or any combinations thereof.

Embodiment 3: The computer implemented method of any preceding embodiment, wherein the geological network forms a spatial structure on which the predicted risk profile segments are located in a CCRS map.

Embodiment 4: The computer implemented method of any preceding embodiment, wherein extracting datasets includes identifying an area and reservoir seal/pair for mapping.

Embodiment 5: The computer implemented method of any preceding embodiment, wherein mapping the containment risk based on the predicted risk profile segments includes superimposing a CCRS map generated based on the predicted risk profile segments with a structural depth map with known inclination.

Embodiment 6: The computer implemented method of any preceding embodiment, wherein the clusters of dense datapoints are obtained by grouping comparable data points based on a similarity of the datapoints.

Embodiment 7: The computer implemented method of any preceding embodiment, wherein the exploration database includes mud logging data, lithology data, overburden data, hydrocarbon shows, geo-facies data, rock properties, production data, or any combinations thereof.

Embodiment 8: An apparatus including a non-transitory, computer readable, storage medium that stores instructions that, when executed by at least one processor, cause the at least one processor to perform operations including: extracting datasets corresponding to wells that satisfy predetermined criteria from an exploration database; integrating the extracted datasets by comparing observations from different extracted datasets to obtain features used to construct a geological network; training an artificial intelligence model to predict risk profile segments for areas corresponding to the exploration database, wherein the artificial intelligence model is iteratively trained using the geological network and clusters of dense datapoints from the exploration database; and mapping a containment risk based on the predicted risk profile segments.

Embodiment 9: The apparatus of any preceding embodiment, the predetermined criteria includes wells with at least one Cement Bond Log (CBL), wells with a drilling well diagram, wells with at least one plug zone, wells with a cement shoe lithology, or any combinations thereof.

Embodiment 10: The apparatus of any preceding embodiment, wherein the geological network forms a spatial structure on which the predicted risk profile segments are located in a CCRS map.

Embodiment 11: The apparatus of any preceding embodiment, wherein extracting datasets includes identifying an area and reservoir seal/pair for mapping.

Embodiment 12: The apparatus of any preceding embodiment, wherein mapping the containment risk based on the predicted risk profile segments includes superimposing a CCRS map generated based on the predicted risk profile segments with a structural depth map with known inclination.

Embodiment 13: The apparatus of any preceding embodiment, wherein the clusters of dense datapoints are obtained by grouping comparable data points based on a similarity of the datapoints.

Embodiment 14: The apparatus of any preceding embodiment, wherein the exploration database includes mud logging data, lithology data, overburden data, hydrocarbon shows, geo-facies data, rock properties, production data, or any combinations thereof.

Embodiment 15: A system, including: one or more memory modules; one or more hardware processors communicably coupled to the one or more memory modules, the one or more hardware processors configured to execute instructions stored on the one or more memory modules to perform operations including: extracting datasets corresponding to wells that satisfy predetermined criteria from an exploration database; integrating the extracted datasets by comparing observations from different extracted datasets to obtain features used to construct a geological network; training an artificial intelligence model to predict risk profile segments for areas corresponding to the exploration database, wherein the artificial intelligence model is iteratively trained using the geological network and clusters of dense datapoints from the exploration database; and mapping a containment risk based on the predicted risk profile segments.

Embodiment 16: The system of any preceding embodiment, the predetermined criteria includes wells with at least one Cement Bond Log (CBL), wells with a drilling well diagram, wells with at least one plug zone, wells with a cement shoe lithology, or any combinations thereof.

Embodiment 17: The system of any preceding embodiment, wherein the geological network forms a spatial structure on which the predicted risk profile segments are located in a CCRS map.

Embodiment 18: The system of any preceding embodiment, wherein extracting datasets includes identifying an area and reservoir seal/pair for mapping.

Embodiment 19: The system of any preceding embodiment, wherein mapping the containment risk based on the predicted risk profile segments includes superimposing a CCRS map generated based on the predicted risk profile segments with a structural depth map with known inclination.

Embodiment 20: The system of any preceding embodiment, wherein the clusters of dense datapoints are obtained by grouping comparable data points based on a similarity of the datapoints.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship. Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

Particular embodiments of the subject matter have been described. Other embodiments are within the scope of the following claims. For example, the actions recited in the claims can be performed in a different order and still achieve desirable results. As one example, some processes depicted in the accompanying figures do not necessarily require the particular order shown, or sequential order, to achieve desirable results.

What is claimed is:

1. A computer-implemented method that enables mapping a containment risk in carbon dioxide (CO2) sequestration, comprising:
extracting datasets corresponding to wells that satisfy predetermined criteria from an exploration database;
integrating the extracted datasets by comparing observations from different extracted datasets to obtain features used to construct a geological network;
training an artificial intelligence model to predict risk profile segments for areas corresponding to the exploration database, wherein the artificial intelligence model is iteratively trained using the geological network and clusters of dense datapoints from the exploration database; and
mapping a containment risk based on the predicted risk profile segments.

2. The computer implemented method of claim 1, the predetermined criteria comprises wells with at least one Cement Bond Log (CBL), wells with a drilling well diagram, wells with at least one plug zone, wells with a cement shoe lithology, or any combinations thereof.

3. The computer implemented method of claim 1, wherein the geological network forms a spatial structure on which the predicted risk profile segments are located in a CCRS map.

4. The computer implemented method of claim 1, wherein extracting datasets comprises identifying an area and reservoir seal/pair for mapping.

5. The computer implemented method of claim 1, wherein mapping the containment risk based on the predicted risk profile segments comprises superimposing a CCRS map generated based on the predicted risk profile segments with a structural depth map with known inclination.

6. The computer implemented method of claim 1, wherein the clusters of dense datapoints are obtained by grouping comparable data points based on a similarity of the datapoints.

7. The computer implemented method of claim 1, wherein the exploration database comprises mud logging data, lithology data, overburden data, hydrocarbon shows, geo-facies data, rock properties, production data, or any combinations thereof.

8. An apparatus comprising a non-transitory, computer readable, storage medium that stores instructions that, when executed by at least one processor, cause the at least one processor to perform operations comprising:
extracting datasets corresponding to wells that satisfy predetermined criteria from an exploration database;
integrating the extracted datasets by comparing observations from different extracted datasets to obtain features used to construct a geological network;
training an artificial intelligence model to predict risk profile segments for areas corresponding to the exploration database, wherein the artificial intelligence model is iteratively trained using the geological network and clusters of dense datapoints from the exploration database; and
mapping a containment risk based on the predicted risk profile segments.

9. The apparatus of claim 8, the predetermined criteria comprises wells with at least one Cement Bond Log (CBL), wells with a drilling well diagram, wells with at least one plug zone, wells with a cement shoe lithology, or any combinations thereof.

10. The apparatus of claim 8, wherein the geological network forms a spatial structure on which the predicted risk profile segments are located in a CCRS map.

11. The apparatus of claim 8, wherein extracting datasets comprises identifying an area and reservoir seal/pair for mapping.

12. The apparatus of claim 8, wherein mapping the containment risk based on the predicted risk profile segments comprises superimposing a CCRS map generated based on the predicted risk profile segments with a structural depth map with known inclination.

13. The apparatus of claim 8, wherein the clusters of dense datapoints are obtained by grouping comparable data points based on a similarity of the datapoints.

14. The apparatus of claim 8, wherein the exploration database comprises mud logging data, lithology data, overburden data, hydrocarbon shows, geo-facies data, rock properties, production data, or any combinations thereof.

15. A system, comprising:
one or more memory modules;
one or more hardware processors communicably coupled to the one or more memory modules, the one or more hardware processors configured to execute instructions stored on the one or more memory modules to perform operations comprising:
extracting datasets corresponding to wells that satisfy predetermined criteria from an exploration database;
integrating the extracted datasets by comparing observations from different extracted datasets to obtain features used to construct a geological network;
training an artificial intelligence model to predict risk profile segments for areas corresponding to the exploration database, wherein the artificial intelligence model is iteratively trained using the geological network and clusters of dense datapoints from the exploration database; and
mapping a containment risk based on the predicted risk profile segments.

16. The system of claim 15, the predetermined criteria comprises wells with at least one Cement Bond Log (CBL), wells with a drilling well diagram, wells with at least one plug zone, wells with a cement shoe lithology, or any combinations thereof.

17. The system of claim 15, wherein the geological network forms a spatial structure on which the predicted risk profile segments are located in a CCRS map.

18. The system of claim 15, wherein extracting datasets comprises identifying an area and reservoir seal/pair for mapping.

19. The system of claim 15, wherein mapping the containment risk based on the predicted risk profile segments comprises superimposing a CCRS map generated based on the predicted risk profile segments with a structural depth map with known inclination.

20. The system of claim 15, wherein the clusters of dense datapoints are obtained by grouping comparable data points based on a similarity of the datapoints.
